(19) United States
(12) Patent Application Publication
(10) Pub. No.: US 2024/0314790 A1
(43) Pub. Date: Sep. 19, 2024

(54) METHOD OF WIRELESS COMMUNICATION AND TERMINAL DEVICE

(71) Applicant: GUANGDONG OPPO MOBILE TELECOMMUNICATIONS CORP., LTD., Dongguan (CN)

(72) Inventors: Wenhong CHEN, Dongguan (CN); Yingpei HUANG, Dongguan (CN)

(21) Appl. No.: 18/675,965

(22) Filed: May 28, 2024

Related U.S. Application Data
(63) Continuation of application No. PCT/CN2021/136714, filed on Dec. 9, 2021.

(51) Int. Cl. H04W 72/21; H04W 72/0446

(52) U.S. Cl. CPC H04W 72/21; H04W 72/0446

(57) ABSTRACT

A method of wireless communication includes: determining by a terminal device, that a physical uplink control channel (PUCCH) and a target physical uplink shared channel (PUSCH) are to be transmitted on a same time domain resource unit, where different transport layers of the target PUSCH are transmitted based on different spatial relation information, or the target PUSCH comprises a plurality of PUSCHs transmitted simultaneously based on different spatial relation information; transmitting by the terminal device, uplink control information (UCI) carried by the PUCCH on the target PUSCH.

### CROSS-REFERENCE TO RELATED APPLICATION

This application is a Bypass Continuation Application of PCT/CN2021/136714 filed Dec. 9, 2021, which is incorporated herein by reference in its entirety.

### TECHNICAL FIELD

Embodiments of the disclosure relate to the field of communication, and in particular, to a method of wireless communication, a terminal device, and a network device.

### BACKGROUND

In related technologies, if a physical uplink shared channel (PUSCH) and a physical uplink control channel (PUCCH) carrying uplink control information (UCI) are transmitted in a same slot or sub-slot, the UCI in the PUCCH will be multiplexed onto the PUSCH for transmission.

### SUMMARY

In a first aspect, a method of wireless communication is provided, including: determining by a terminal device, that a physical uplink control channel (PUCCH) and a target physical uplink shared channel (PUSCH) are to be transmitted on a same time domain resource unit, where different transport layers of the target PUSCH are transmitted based on different spatial relation information, or the target PUSCH includes a plurality of PUSCHs transmitted simultaneously based on different spatial relation information; transmitting by the terminal device, uplink control information (UCI) carried by the PUCCH on the target PUSCH.

In a second aspect, a wireless communication method is provided, including: scheduling by a network device, a physical uplink control channel (PUCCH) and a target physical uplink shared channel (PUSCH) to be transmitted on a same time domain resource unit, where different transport layers of the target PUSCH are transmitted based on different spatial relation information, or the target PUSCH includes a plurality of PUSCHs transmitted simultaneously based on different spatial relation information; receiving by the network device, uplink control information (UCI) carried by the PUCCH, transmitted by a terminal device on the target PUSCH.

In a third aspect, a terminal device is provided for performing the method in the above first aspect or its various implementations.

Specifically, the terminal device includes a functional module for performing the method in the above first aspect or its various implementations.

In a fourth aspect, a network device is provided for performing the method in the above second aspect or its various implementations.

Specifically, the network device includes a functional module for performing the method in the above second aspect or its various implementations.

In a fifth aspect, a terminal device is provided, including a processor and a memory. The memory is configured to store a computer program, and the processor is configured to invoke and execute the computer program stored in the memory to perform the method in the above first aspect or its various implementations.

In a sixth aspect, a network device is provided, including a processor and a memory. The memory is configured to store a computer program, and the processor is configured to involve and execute the computer program stored in the memory, to perform the method in the above second aspect or its various implementations.

In a seventh aspect, a chip is provided for implementing the method in any one of the above first aspect to the second aspect or their various implementations.

Specifically, the chip includes: a processor, configured to invoke and execute a computer program from a memory, causing the device installed with the apparatus to perform the method in any one of the above first aspect to second aspect or their various implementations.

In an eighth aspect, a non-transitory computer readable storage medium is provided, for storing a computer program, where the computer program causes a computer to perform the method in any one of the above first aspect to the second aspect or their various implementations.

In a ninth aspect, a computer program product is provided, including a computer program instruction, where the computer program instruction causes a computer to perform the method of any one of the above first aspect to the second aspect or their various implementations.

In a tenth aspect, a computer program is provided, where the computer program, when being executed on a computer, causes the computer to perform the method in any one of the above first aspect to the second aspect or their various implementations.

### BRIEF DESCRIPTION OF THE DRAWINGS

FIG. 1 is a schematic diagram of a communication system architecture, provided by the embodiments of the disclosure.

FIG. 2 is a schematic diagram of an uplink transmission based on multi-TRP, provided by the disclosure.

FIG. 3 is a schematic diagram of another uplink transmission based on multi-TRP, provided by the disclosure.

FIG. 4 is a schematic diagram of a PUCCH transmission based on multi-TRP, provided by the disclosure.

FIG. 5 is a schematic diagram of configuring TCI states, provided by the disclosure.

FIG. 6 is a schematic interaction diagram of a method of wireless communication, provided by the embodiments of the disclosure.

FIG. 7 is a schematic block diagram of a terminal device, provided by the embodiments of the disclosure.

FIG. 8 is a schematic block diagram of a network device, provided by the embodiments of the disclosure.

FIG. 9 is a schematic block diagram of a communication device, provided by the embodiments of the disclosure.

FIG. 10 is a schematic block diagram of a chip, provided by the embodiments of the disclosure.

FIG. 11 is a schematic block diagram of a communication system, provided by the embodiments of the disclosure.

### DETAILED DESCRIPTION

The technical solutions in the embodiments of the disclosure will be described in conjunction with the accompanying drawings in the embodiments of the disclosure. Apparently, the described embodiments are a part of the embodiments of the disclosure, but not all of the embodiments. For the embodiments of the disclosure, all other embodiments obtained by the ordinary skilled in the art belong to the protection scope of the disclosure.

The technical solutions of the embodiments of the disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Networks (WLAN), a Wireless Fidelity (WiFi), a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc, and the embodiments of the disclosure may also be applied to these communication systems.

Optionally, the communication system in the embodiments of the disclosure may be applied to a carrier aggregation (CA) scenario, may also be applied to a dual connectivity (DC) scenario, and may also be applied to a standalone (SA) network deployment scenario.

Optionally, the communication system in the embodiments of the disclosure may be applied to an unlicensed spectrum, where the unlicensed spectrum may also be considered as a shared spectrum; or the communication system in the embodiments of the disclosure may also be applied to a licensed spectrum, where the licensed spectrum may also be considered as an unshared spectrum.

The embodiments of the disclosure describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the disclosure, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the disclosure, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, etc.

As an example but not a limitation, in the embodiments of the disclosure, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, eNB or eNodeB) in the LTE, or a relay station or an access point, or a network device (gNB) in a vehicle-mounted device, a wearable device and an NR network, or a network device in the PLMN network evolved in the future or a network device in the NTN network, etc.

As an example but not a limitation, in the embodiments of the disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station provided on land, water, and other places.

In the embodiments of the disclosure, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc, these small cells have characteristics of small coverage range and low transmission power, which are applicable for providing a data transmission service with high speed.

As mentioned above, if a physical uplink shared channel (PUSCH) and a physical uplink control channel (PUCCH) carrying uplink control information (UCI) are transmitted in a same slot or sub-slot, the UCI in the PUCCH will be multiplexed onto the PUSCH for transmission. However, if the PUSCH is transmitted on a plurality of antenna panels, for example, different transport layers of the PUSCH are transmitted on different panels, or different PUSCHs are transmitted on different panels simultaneously, in this case, how to multiplex the UCI in the PUCCH onto the PUSCH for transmission by a terminal device is an urgent problem to be solved.

The present disclosure provides a method of wireless communication applicable to a terminal device, which includes the following steps:
determining by a terminal device, that a physical uplink control channel (PUCCH) and a target physical uplink shared channel (PUSCH) are to be transmitted on a same time domain resource unit, where different transport layers of the target PUSCH are transmitted based on different spatial relation information, or the target PUSCH includes a plurality of PUSCHs transmitted simultaneously based on different spatial relation information;
transmitting by the terminal device, uplink control information (UCI) carried by the PUCCH on the target PUSCH.

In a possible implementation, different transport layers of the target PUSCH are transmitted based on different spatial relation information, transmitting by the terminal device, the uplink control information (UCI) carried by the PUCCH on the target PUSCH, includes:
transmitting by the terminal device, the UCI on all transport layers of the target PUSCH based on different spatial relation information; or
transmitting by the terminal device, the UCI on a first-type transport layer of the target PUSCH, where the first-type transport layer is related to a transmission parameter of the PUCCH; or
transmitting by the terminal device, the UCI on a second-type transport layer of the target PUSCH;
where the second-type transport layer is a first transport layer of the target PUSCH, or the second-type transport layer is a transport layer transmitted on a first antenna panel of the terminal device, or the second-type transport layer is a transport layer with an associated antenna panel identifier of 0, or the second-type transport layer is a transport layer associated with a first reference signal resource set.

In a possible implementation, the first-type transport layer being related to the transmission parameter of the PUCCH, includes at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

In a possible implementation, transmitting by the terminal device, the uplink control information (UCI) carried by the PUCCH on the target PUSCH, includes:
prioritizing to transmit by the terminal device, the UCI on the first-type transport layer of the target PUSCH;
in a case where there isn't the first-type transport layer satisfying a condition, transmitting by the terminal device, the UCI on the second-type transport layer of the target PUSCH, or transmitting by the terminal device, the UCI on all transport layers of the target PUSCH based on different spatial relation information.

In a possible implementation, the target PUSCH includes a plurality of PUSCHs transmitted simultaneously based on different spatial relation information, transmitting by the terminal device. The uplink control information (UCI) carried by the PUCCH on the target PUSCH includes:
transmitting by the terminal device, the UCI on the plurality of PUSCHs simultaneously based on different spatial relation information; or
transmitting by the terminal device, the UCI on a first PUSCH of the plurality of PUSCHs, where the first PUSCH is related to a transmission parameter of the PUCCH; or
transmitting by the terminal device, the UCI on a second PUSCH of the plurality of PUSCHs;
where the second PUSCH is a PUSCH transmitted on a first antenna panel of the terminal device, or the second PUSCH is a PUSCH with an associated antenna panel identifier of 0, or the second PUSCH is a PUSCH associated with a first reference signal resource set, or the second PUSCH is a PUSCH with an associated control resource set (CORESET) pool index of 0, or the second PUSCH is a PUSCH starting to be transmitted at the earliest among the plurality of PUSCHs, or the second PUSCH is a PUSCH scheduled at the earliest among the plurality of PUSCHs; or the second PUSCH is a PUSCH with a highest modulation and coding scheme (MCS) level among the plurality of PUSCHs.

In a possible implementation, the first PUSCH being related to the transmission parameter of the PUCCH includes at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

In a possible implementation, transmitting by the terminal device, the uplink control information (UCI) carried by the PUCCH on the target PUSCH, includes:
prioritizing to transmit by the terminal device, the UCI on the first PUSCH;
in a case where there isn't the first PUSCH satisfying a condition, transmitting by the terminal device, the UCI on the second PUSCH, or transmitting by the terminal device, the UCI on the plurality of PUSCHs simultaneously based on different spatial relation information.

Optionally, the method further includes:
determining by the terminal device, a PUSCH used to transmit the UCI among the plurality of PUSCHs, according to whether the plurality of PUSCHs transmit same transport blocks.

In a possible implementation, determining by the terminal device, the PUSCH used to transmit the UCI among the plurality of PUSCHs, according to whether the plurality of PUSCHs transmit the same transport blocks, includes:
if the plurality of PUSCHs transmit different transport blocks, transmitting the UCI on the first PUSCH of the plurality of PUSCHs, or transmitting the UCI on the second PUSCH of the plurality of PUSCHs;
if the plurality of PUSCHs transmit the same transport blocks, transmitting the UCI on the plurality of PUSCHs simultaneously based on different spatial relation information.

In a possible implementation, different transport layers of the target PUSCH are transmitted on different antenna panels based on different spatial relation information. The plurality of PUSCHs included in the target PUSCH are transmitted simultaneously on different antenna panels based on different spatial relation information.

Optionally, the reference signal resource set is a channel state information reference signal (CSI-RS) resource set, or a sounding reference signal (SRS) resource set, or a synchronization signal block (SSB) set carrying a same physical cell identifier (PCI).

Optionally, the spatial relation information is a sounding reference signal resource indicator (SRI), or physical uplink control channel (PUCCH) spatial relation information or a transmission configuration indicator (TCI) state.

Optionally, the time domain resource unit is a slot, a sub-slot, or an orthogonal frequency division multiplexing (OFDM) symbol.

The present disclosure further provides a method of wireless communication applicable to a network device, which includes the following steps:
scheduling by a network device, a physical uplink control channel (PUCCH) and a target physical uplink shared channel (PUSCH) to be transmitted on a same time domain resource unit, where different transport layers of the target PUSCH are transmitted based on different spatial relation information, or the target PUSCH includes a plurality of PUSCHs transmitted simultaneously based on different spatial relation information;
receiving by the network device, uplink control information (UCI) carried by the PUCCH, transmitted by a terminal device on the target PUSCH.

In a possible implementation, different transport layers of the target PUSCH are transmitted based on different spatial relation information. Receiving by the network device, the uplink control information (UCI) carried by the PUCCH, transmitted by the terminal device on the target PUSCH includes:
receiving by the network device, the UCI transmitted by the terminal device on all transport layers of the target PUSCH based on different spatial relation information; or
receiving by the network device, the UCI on a first-type transport layer of the target PUSCH, where the first-type transport layer is related to a transmission parameter of the PUCCH; or
receiving by the network device, the UCI on a second-type transport layer of the target PUSCH,
where the second-type transport layer is a first transport layer of the target PUSCH, or the second-type transport layer is a transport layer transmitted on a first antenna panel of the terminal device, or the second-type transport layer is a transport layer with an associated antenna panel identifier of 0, or the second-type transport layer is a transport layer associated with a first reference signal resource set.

In a possible implementation, the first-type transport layer being related to the transmission parameter of the PUCCH includes at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set;
the first-type transport layer and the PUCCH being associated with a same antenna panel identifier.

In a possible implementation, receiving by the network device, the uplink control information (UCI) carried by the PUCCH, transmitted by the terminal device on the target PUSCH, includes:
prioritizing to receive by the network device, the UCI on the first-type transport layer of the target PUSCH;
in a case where there isn't the first-type transport layer satisfying a condition, receiving the UCI on the second-type transport layer of the target PUSCH, or receiving the UCI transmitted simultaneously by the terminal device on all transport layers of the target PUSCH based on different spatial relation information.

In a possible implementation, the target PUSCH includes a plurality of PUSCHs transmitted simultaneously based on different spatial relation information. Receiving by the network device, the uplink control information (UCI) carried by the PUCCH, transmitted by the terminal device on the target PUSCH, includes:
receiving by the network device, the UCI simultaneously transmitted by the terminal device on the plurality of PUSCHs based on different spatial relation information; or
receiving by the network device, the UCI on a first PUSCH of the plurality of PUSCHs, where the first PUSCH is related to a transmission parameter of the PUCCH; or
receiving by the network device, the UCI on a second PUSCH of the plurality of PUSCHs;
where the second PUSCH is a PUSCH transmitted on a first antenna panel of the terminal device; or the second PUSCH is a PUSCH with an associated antenna panel identifier of 0; or the second PUSCH is a PUSCH associated with a first reference signal resource set; or the second PUSCH is a PUSCH with an associated control resource set (CORESET) pool index of 0; or the second PUSCH is a PUSCH starting to be transmitted at the earliest among the plurality of PUSCHs; or the second PUSCH is a PUSCH scheduled at the earliest among the plurality of PUSCHs; or the second PUSCH is a PUSCH with a highest modulation and coding scheme (MCS) level among the plurality of PUSCHs.

In a possible implementation, the first PUSCH being related to the transmission parameter of the PUCCH includes at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

In a possible implementation, receiving by the network device, the uplink control information (UCI) carried by the PUCCH, transmitted by the terminal device on the target PUSCH, includes:
prioritizing to receive by the network device, the UCI on the first PUSCH;
in a case where there isn't the first PUSCH satisfying a condition, receiving the UCI on the second PUSCH, or receiving the UCI simultaneously transmitted by the terminal device on the plurality of PUSCHs based on different spatial relation information.

Optionally, the method further includes:
determining by the network device, a PUSCH used to receive the UCI among the plurality of PUSCHs, according to whether the plurality of PUSCHs transmit same transport blocks.

In a possible implementation, determining by the network device, the PUSCH used to receive the UCI among the plurality of PUSCHs, according to whether the plurality of PUSCHs transmit the same transport blocks, includes:
if the plurality of PUSCHs transmit different transport blocks, receiving the UCI on the first PUSCH of the plurality of PUSCHs, or receiving the UCI on the second PUSCH of the plurality of PUSCHs; and/or
if the plurality of PUSCHs transmit the same transport blocks, receiving the UCI simultaneously transmitted by the terminal device on the plurality of PUSCHs based on different spatial relation information.

In a possible implementation, different transport layers of the target PUSCH are transmitted on different antenna panels based on different spatial relation information;

Optionally, the plurality of PUSCHs included in the target PUSCH are transmitted simultaneously on different antenna panels based on different spatial relation information.

Optionally, the reference signal resource set is a channel state information reference signal (CSI-RS) resource set, or a sounding reference signal (SRS) resource set, or a synchronization signal block (SSB) set carrying a same physical cell identifier (PCI).

Optionally, the spatial relation information is a sounding reference signal resource indicator (SRI), or a physical uplink control channel (PUCCH) spatial relation information or a transmission configuration indicator (TCI) state.

Optionally, the time domain resource unit is a slot, a sub-slot, or an orthogonal frequency division multiplexing (OFDM) symbol.

Exemplarily, the communication system 100 applied by the embodiments of the disclosure is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and optionally, the communication system 100 may include a plurality of network devices and may include another number of terminal devices within a coverage range of each network device, the embodiments of the disclosure are not limited thereto.

Optionally, the communication system 100 may also include other network entities such as a network controller and a mobility management entity, etc., which are not limited in the embodiments of the disclosure.

It should be understood that, in the embodiments of the disclosure, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the specific devices described above, which will not be repeated herein; the communication device may also include other devices in the communication system 100, such as a network controller, a mobility management entity, and other network entities, which are not limited in the embodiments of the disclosure.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that, “indication” mentioned in the embodiments of the disclosure may be direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the disclosure, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the disclosure, “predefined” may be implemented by pre-saving corresponding codes, tables or other manners that may be used for indicating related information, in the device (for example, including the terminal device and the network device), and the disclosure does not limit its specific implementation. For example, the predefined may refer to what is defined in a protocol.

In the embodiments of the disclosure, the “protocol” may refer to a standard protocol in the field of communication, which may include, for example, an LTE protocol, an NR protocol, and related protocols applied in the future communication system, and the disclosure is not limited thereto.

To facilitate the understanding of the technical solutions of the embodiments of the disclosure, an uplink antenna array block or an antenna panel related to the disclosure is described. In the following embodiments, an antenna panel is used as an example for description, which may also be replaced by an antenna array block.

With the continuous evolution of an antenna packaging technology, a plurality of antenna elements may be nested and combined with a chip to form a panel, which makes it possible to configure a plurality of panels with low-correlation in a transmitter. Through a beamforming technology of multi-antenna, transmission signal energy is concentrated in a certain direction for transmission, which may effectively improve coverage, thereby improving performance of the communication. Radio frequency links of a plurality of panels are independent, each panel of a plurality of panels may independently form a transmission beam, and beams formed by different panels may be the same or different. Therefore, a terminal transmitter may send a data stream on a plurality of panels simultaneously through different beams, to improve the capacity or reliability of the transmission.

The terminal device needs to notify the network side of a number of the configured antenna panels, in a capability report. At the same time, the terminal device may also need to notify the network side whether it has an ability to transmit a signal on a plurality of antenna panels simultaneously. Since channel conditions corresponding to different panels are different, different panels need to adopt different transmission parameters according to their respective channel information. In order to obtain these transmission parameters, different sounding reference signal resources (SRS Resources) need to be configured for different panels, to obtain uplink channel information. For example, in order to perform beam management of uplink, an SRS resource set may be configured for each panel, so that each panel performs the beam management separately and determines an independent analog beam. In order to obtain precoding information used by Physical Uplink Shared Channel (PUSCH) transmission, an SRS resource set may also be configured for each panel, the SRS resource set is used to obtain a transmission parameter, such as a beam, a precoding vector, and a number of transport layers, etc., used by the PUSCH transmitted on the panel. At the same time, the multi-panel transmission may also be applied to Physical Uplink Control Channel (PUCCH), that is, information carried by a PUCCH resource or PUCCH resources on a same time domain resource may be sent to the network side by different panels simultaneously. Herein, each panel may have its own panel ID, which is used to associate different signals transmitted on a same panel, that is, the terminal device may consider that signals associated with a same panel ID need to be transmitted from a same panel.

In order to facilitate the understanding of the technical solutions of the embodiments of the disclosure, an uplink non-coherent transmission related to the disclosure is described.

In the NR system, a downlink and uplink non-coherent transmission based on a plurality of transmission reception points (TRPs) is introduced. Herein, A backhaul connection between TRPs may be ideal or non-ideal. Information may be exchanged quickly and dynamically between TRPs under ideal backhaul, and information may be exchanged just quasi-statically between TRPs under non-ideal backhaul due to large latency. In a downlink non-coherent transmission, a plurality of TRPs may independently schedule a plurality of physical downlink shared channel (PDSCH) transmissions of a terminal device based on different control channels, or transmissions of different TRPs may be scheduled based on a same control channel, where data of different TRPs is based on different transport layers, and the latter method can only be used in the case of the ideal backhaul.

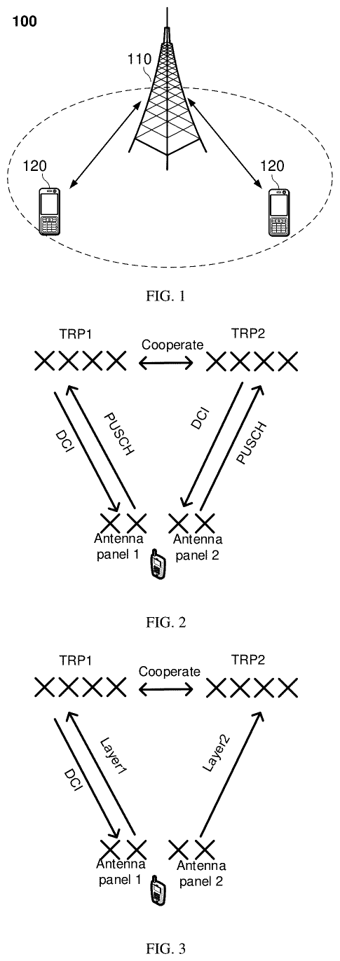

In an uplink non-coherent transmission, different TRPs may also independently schedule PUSCH transmissions of a same terminal device. Different PUSCH transmissions may be configured with independent transmission parameters, such as a beam, a precoding matrix, a number of layers, etc. The scheduled PUSCH transmission may be transmitted on a same slot or on different slots. If the terminal device is scheduled with two PUSCH transmissions at a same slot simultaneously, it needs to determine how to perform the transmission based on its own capability. If the terminal device is configured with a plurality of panels and supports the simultaneous transmission of PUSCHs on the plurality of panels, the terminal device may transmit the two PUSCHs simultaneously, and the PUSCHs transmitted on different panels are aligned to the respective TRPs for analog forming, thereby distinguishing different PUSCHs by the spatial domain, and improving spectrum efficiency of the uplink (as shown in FIG. 2). If the terminal device only has a single panel, or does not support the simultaneous transmission of a plurality of panels, the terminal device can transmit PUSCHs only on one panel. Similar to downlink, PUSCHs transmitted by different TRPs may be scheduled based on a plurality of downlink control information (DCI), and these DCI may be carried by different control resource sets (CORESETs). Specifically, a plurality of CORESET groups are configured at the network side, and each TRP schedules based on a CORESET in the respective CORESET group, that is, different TRPs may be distinguished by CORESET groups. For example, the network device may configure a CORESET pool index for each CORESET, and different indexes indicate that different CORESE groups correspond to different TRPs. Similarly, PUSCHs transmitted to different TRPs, may be scheduled based on single DCI, and at this time, beams and demodulation reference signal (DMRS) ports on which PUSCH transport layers transmitted to different TRPs are based respectively, need to be indicated in the DCI (as shown in FIG. 3), that is, a transport layer with a different PUSCH may be transmitted on a different panel.

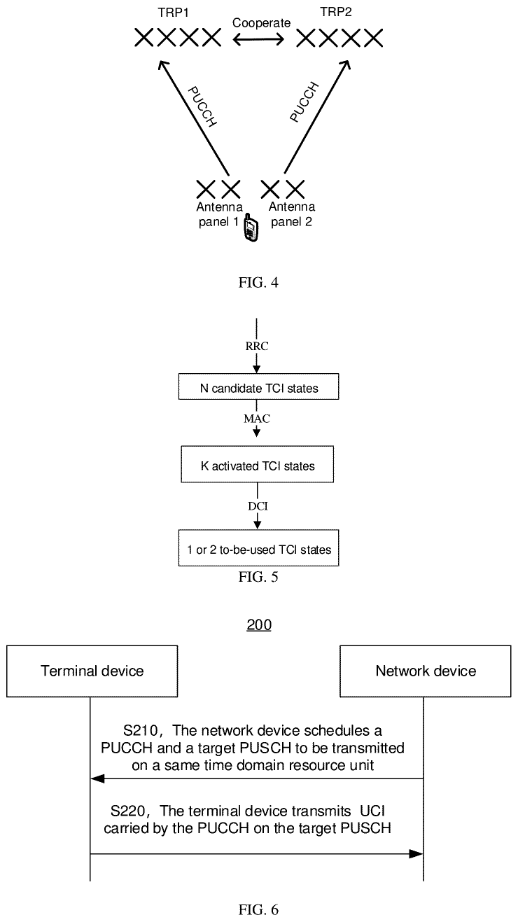

A similar method may also be used for a PUCCH transmission. That is, the terminal device may configure different PUCCHs to be transmitted on different panels simultaneously, to be based on different beams on the different panels, to be each notified to the terminal device by their respective spatial relation information. Taking two different PUCCHs being transmitted on different panels as an example, as shown in FIG. 4, the PUCCHs transmitted on the different panels may be used to carry uplink control information (UCI) sent to different TRPs, for example, UCI on a panel 1 is sent to a TRP1, while UCI on a panel 2 is sent to a TRP2.

In order to facilitate the understanding of the technical solutions of the embodiments of the disclosure, the uplink beam management related to the disclosure is described.

In the NR system, the terminal device may use an analog beam to transmit uplink data and uplink control information. The terminal device may perform the uplink beam management based on a SRS signal, to determine an analog beam used by an uplink transmission. Specifically, the network device may configure an SRS resource set 1 for the terminal device, the SRS resource set 1 includes N SRS resources (where N>1). The terminal device may use different beams to transmit the N SRS resources, and the network side measures reception quality of the N SRS resources respectively, and selects K SRS resources with the best reception quality among the N SRS resources. The network side may configure an SRS resource set 2 again, which includes K SRS resources, and instructs the terminal to transmit SRS resources in the SRS resource set 2 by using an analog beam used by the K SRS resources selected among the SRS resource set 1. This may be implemented by configuring the K SRS resources selected among the SRS resource set 1 as reference SRS resources of K SRS resources in the SRS resource set 2 respectively. At this time, based on SRSs transmitted by the terminal device in the SRS resource set 2, the network side may select an SRS resource with the best reception quality and notify the terminal device of a corresponding SRS resource indicator (Sounding Reference Signal Resource Indicator, SRI). After receiving the SRI, the terminal device determines an analog beam used by an SRS resource indicated by the SRI as an analog beam used by transmitting the PUSCH.

In order to determine a beam used by a PUCCH transmission, in the NR system, a manner of Radio Resource Control (RRC) plus Media Access Control (MAC) signaling is used to indicate a beam used by transmitting UCI on each PUCCH resource. Specifically, spatial relation information (PUCCH-spatialrelationinfo) of N PUCCHs is first configured by a high-layer signaling, and then spatial relation information corresponding to each PUCCH resource is determined from the N PUCCH-spatialrelationinfo by a MAC signaling.

In order to facilitate a better understanding of the embodiments of the disclosure, a quasi-co-located (QCL) indication of a downlink signal transmission related to the disclosure is described.

In the NR system, the network device may configure a corresponding transmission configuration indicator (TCI) state for each downlink signal or each downlink channel, to indicate a QCL reference signal corresponding to a target downlink signal or a target downlink channel, so that the terminal performs receiving of the target downlink signal or the target downlink channel based on the reference signal.

Herein, a TCI state may contain the following configuration:
a TCI state ID, for identifying a TCI state;
QCL information 1;
QCL information 2.

Herein, a piece of QCL information also includes the following information:
QCL type configuration, which may be one of QCL type A, QCL type B, QCL type C, and QCL type D;
QCL reference signal configuration, including a cell ID where the reference signal is located, a bandwidth part (Band Width Part, BWP) ID, and an identifier of the reference signal (which may be a channel state information reference signal (CSI-RS) resource ID or Synchronization Signal Block (SSB) index).

Herein, the QCL type of at least one QCL information of the QCL information 1 and the QCL information 2 must be one of type A, type B, and type C, and the QCL type of another QCL information (if configured) must be QCL type D.

Herein, definitions of different QCL type configuration are as follows:
‘QCL-Type A’: {Doppler shift, Doppler spread, average delay, delay spread};
‘QCL-Type B’: {Doppler shift, Doppler spread};
‘QCL-Type C’: {Doppler shift, average delay};
‘QCL-Type D’: {Spatial Rx parameter}.

If the network device configures a QCL reference signal of a target downlink channel as a reference SSB or a reference CSI-RS resource by a TCI state, and the QCL type configuration is type A, type B, or type C, the terminal device may assume that a target large-scale parameter of the target downlink channel is same as a target large-scale parameter of the reference SSB or the reference CSI-RS resource, and thus, use a same corresponding reception parameter for reception, and the target large-scale parameter is determined by the QCL type configuration. Similarly, if the network device configures a QCL reference signal of a target downlink channel as a reference SSB or a reference CSI-RS resource by a TCI state, and the QCL type configuration is type D, the terminal device may receive the target downlink channel by using a same reception beam as for receiving the reference SSB or the reference CSI-RS resource (ie, Spatial Rx parameter). Generally, the target downlink channel, and its reference time synchronization/broadcast channel (SSB/PBCH) or reference CSI-RS resource are transmitted by a same TRP or a same antenna panel or a same beam at the network side. If transmission TRPs or transmission panels or transmission beams of two downlink signals or downlink channels are different, different TCI states are usually configured.

For a downlink control channel, a TCI state may be indicated in a manner of a radio resource control (RRC) signaling or a combination of an RRC signaling and a MAC signaling. For a downlink data channel, an available TCI state set is indicated by an RRC signaling, and a part of TCI states of the TCI state set are activated by a Media Access Control (MAC) layer signaling, and finally, one or two TCI states are indicated from the activated TCI states by a TCI state indication field in the DCI, for a PDSCH scheduled by the DCI. For example, as shown in FIG. 5, the network device indicates N candidate TCI states by a RRC signaling, and activates K TCI states by a MAC signaling, and finally, indicates one or two to-be-used TCI states from the activated TCI states by the TCI state indication field in the DCI.

In related technologies, if a PUSCH and a PUCCH carrying a UCI are transmitted in a same slot or sub-slot, the UCI in the PUCCH will be multiplexed into the PUSCH for transmission. However, if the PUSCH is transmitted on a plurality of panels, for example, different transport layers are transmitted on different panels, or different PUSCHs are transmitted on different panels simultaneously, in this case, how to multiplex the UCI in the PUCCH onto the PUSCH for transmission by the terminal device is an urgent problem to be solved.

In order to facilitate the understanding of technical solutions of the embodiments of the disclosure, the technical solutions of the disclosure are described in detail below through specific embodiments. The following related technologies, as optional solutions, may be randomly combined with the technical solutions of the embodiments of the disclosure, which all belong to the protection scope of the embodiments of the disclosure. The embodiments of the disclosure include at least a part of the following contents.

FIG. 6 is a schematic interaction diagram of a method 200 of wireless communication according to the embodiments of the disclosure, as shown in FIG. 6, the method 200 includes at least a part of the following content.

S210, scheduling by a network device, a physical uplink control channel (PUCCH) and a target physical uplink shared channel (PUSCH) to be transmitted on a same time domain resource unit, where different transport layers of the target PUSCH are transmitted based on different spatial relation information, or the target PUSCH includes a plurality of PUSCHs transmitted simultaneously based on different spatial relation information.

Correspondingly, the terminal device determines that the PUCCH and the target PUSCH are transmitted on the same time domain resource unit.

S220, transmitting by the terminal device, uplink control information (UCI) carried by the PUCCH on the target PUSCH.

Correspondingly, the network device receives the UCI carried by the PUCCH, transmitted by the terminal device on the target PUSCH.

For ease of distinguishment and description, in the embodiments of the disclosure, a scenario where different transport layers of the target PUSCH are transmitted based on different spatial relation information, is denoted as a case 1; a scenario where the target PUSCH includes a plurality of PUSCHs transmitted simultaneously based on different spatial relation information, is denoted as a case 2.

For the case 1, the target PUSCH may be scheduled by a single DCI. Herein, different transport layers of the target PUSCH may be transmitted on different panels.

For the case 2, the target PUSCH may be scheduled by a plurality of DCIs, in this case, the plurality of PUSCHs included in the target PUSCH are used to transmit different transport blocks (TBs) or same TBs, or the target PUSCH may be scheduled by a single DCI, in this case, the plurality of PUSCHs included in the target PUSCH are used to transmit the same TBs.

That is, for the case 2, the plurality of PUSCHs may carry the same data (corresponding to a scenario of a repeated transmission of a PUSCH), or the plurality of PUSCHs may carry different data (corresponding to a scenario of a multiplexed transmission of a PUSCH). That is, a plurality of repeated transmissions of the PUSCH may be scheduled by a single DCI, or different PUSCHs may be scheduled to be transmitted simultaneously by a plurality of DCIs, for example, different TRPs schedule independently by different DCIs, different PUSCHs to be transmitted simultaneously.

It should be understood that, in the embodiments of the disclosure, a time domain resource unit may be a slot, a sub-slot or an orthogonal frequency-division multiplexing (OFDM) symbol, etc, the disclosure isn't limited thereto, and in the following description, a time domain resource unit as a slot is taken as an example for description, but the disclosure is not limited thereto.

In some embodiments of the disclosure, the terminal device receives configuration information or scheduling information of the network device, which is used to schedule the PUCCH and the target PUSCH, and the PUCCH and the target PUSCH are transmitted in a same slot. Herein, information used for scheduling/configuring the PUCCH and information used for configuring/scheduling the PUSCH may be different information.

For the case 1, the target PUSCH includes one PUSCH, and then the PUCCH and the target PUSCH being transmitted in a same slot may include: the PUCCH and the one PUSCH overlap within one slot.

For the case 2, the target PUSCH includes a plurality of PUSCHs, and then the PUCCH and the target PUSCH being transmitted in a same slot may include: the PUCCH and the plurality of PUSCHs overlap within one slot.

It should be understood that, the PUCCH and the plurality of PUSCHs overlaping within one slot may include:
physical resources of the PUCCH and the plurality of PUSCHs overlapping, for example, orthogonal frequency division multiplexing (OFDM) symbols occupied by the PUCCH and the plurality of PUSCHs within one slot overlapping; or,
the PUCCH and the plurality of PUSCHs occupying a same slot, but occupying same or different OFDM symbols within the same slot.

In some embodiments of the disclosure, the spatial relation information is used to determine a transmitting beam and/or transmitting panel of a target PUSCH.

For example, the terminal device may determine one indicated reference signal according to spatial relation information of the target PUSCH, and furthermore, the terminal device may use a transmitting beam or a receiving beam of the reference signal as a transmitting beam of the target PUSCH, or use a transmitting panel or a receiving panel of the reference signal to transmit the target PUSCH.

In some embodiments, the spatial relation information is used to determine the transmitting beam of the target PUSCH, and at this time, the terminal device may determine transmission timing of the target PUSCH according to the reference signal used to determine the transmitting beam, or the spatial relation information may additionally include one reference signal used to determine uplink timing.

In the embodiments of the disclosure, the transmitting beam may also be referred to as a spatial domain transmission filter (or spatial domain filter for transmission), spatial relation, or spatial configuration (spatial setting). The receiving beam may also be referred to as a spatial domain reception filter or spatial domain filter for reception or a spatial Rx parameter. The spatial relation information is information related to a spatial domain reception/transmission. Because spatial domain reception/transmission of information is directly related to a beam, the spatial relation information is also information related to a beam.

In some embodiments, the reference signal may be a synchronization signal block (SSB) or a channel state information reference signal (CSI-RS) or an SRS.

Optionally, when the reference signal is an SSB or a CSI-RS resource, the terminal device may transmit the target PUSCH by using a receiving beam or a receiving panel of the reference signal; when the reference signal is an SRS, the terminal device may transmit the target PUSCH by using a transmitting beam or a transmitting panel of the reference signal.

In some embodiments, the spatial relation information may be an SRI, or PUCCH spatial relation information (PUCCH-spatialrelationinfo) or a TCI state, or other reference information characterizing spatial domain information, the disclosure isn't limited thereto. It should be understood that a specific implementation of the above spatial relation information may be substituted relatively.

For example, for the PUSCH, the spatial relation information may be an SRI included in DCI or an RRC signaling, to indicate one SRS resource; for the PUCCH, the spatial relation information may be PUCCH spatial relation information indicated by a high-layer signaling; for the PUCCH and the PUSCH, the spatial relation information may also be a TCI state, and the TCI state may be configured by a high-layer signaling and indicated to the terminal device by DCI.

In some embodiments, the terminal device may receive a plurality of reference signal resource sets configured by the network device, and for different reference signal resource sets, the terminal device may use different panels to transmit or receive a reference signal, and the spatial relation information indicates a reference signal resource in a reference signal resource set of the plurality of reference signal resource sets, and thus, the terminal device may determine a corresponding panel by the reference signal resource and the reference signal resource set.

For example, the network device may configure a plurality of CSI-RS resource sets, and for different CSI-RS resource sets, the terminal device receives CSI-RSs on different panels; or the network device may configure a plurality of SRS resource sets, and for different SRS resource sets, the terminal device transmits SRSs on different panels; or, the network device may indicate a plurality of physical cell identifiers (PCIs), and SSBs associated with each PCI is used as an SSB set, so that for different SSB sets, the terminal device may receive SSBs on different panels.

For the case 1:

In some embodiments, different transport layers of the target PUSCH being transmitted based on different spatial relation information, may include:
different transport layers of the target PUSCH being transmitted on different antenna panels based on different spatial relation information.

For example, different transport layers of the target PUSCH are transmitted on different panels based on different SRIs, or different transport layers of the target PUSCH are transmitted on different panels based on different TCI states.

In some implementations, a first signaling (for example, DCI or an RRC signaling, etc.) for scheduling the target PUSCH may indicate a plurality of SRIs, and different transport layers of the target PUSCH perform an uplink transmission based on different SRIs, for example, different transport layers of the target PUSCH determine different transmitting beams or transmitting panels based on different SRIs. As an example, the plurality of SRIs include two SRIs, then a first-type transport layer of the target PUSCH may perform an uplink transmission on a first panel based on a first SRI, while a second-type transport layer of the target PUSCH may perform an uplink transmission on a second panel based on a second SRI.

In some other implementations, a second signaling (e.g., DCI or an RRC signaling, etc.) for scheduling the target PUSCH may indicate a plurality of TCI states, different transport layers of the target PUSCH perform an uplink transmission based on different TCI states, for example, different transport layers of the target PUSCH determine different transmitting beams or transmitting panels based on different TCI states. As an example, the plurality of TCI states include two TCI states, then a first-type transport layer of the target PUSCH may perform an uplink transmission on a first panel based on a first TCI state, and a second-type transport layer of the target PUSCH may perform an uplink transmission on a second panel based on a second TCI state.

For the case 2:

In some embodiments, a plurality of PUSCHs included in the target PUSCH being transmitted simultaneously based on different spatial relation information, may mean: the plurality of PUSCHs included in the target PUSCH being transmitted simultaneously on different antenna panels based on different spatial relation information.

For example, the plurality of PUSCHs included in the target PUSCH are transmitted on different panels based on different SRIs, or the plurality of PUSCHs included in the target PUSCH are transmitted on different panels based on different TCI states.

In an implementation, the terminal device may receive a plurality of third signalings (e.g., DCI or RRC signalings), each third signaling is used to schedule one PUSCH, and the scheduled PUSCH is transmitted simultaneously (e.g., OFDM symbols overlap), that is, the plurality of third signalings may be used to schedule a plurality of PUSCHs that are transmitted simultaneously. For example, the plurality of third signalings are used to schedule the plurality of PUSCHs to be transmitted simultaneously on different panels. Each third signaling of the plurality of third signalings indicates one SRI or TCI state, to determine a transmitting beam and/or a transmitting panel of the scheduled PUSCH. As an example, the plurality of third signalings include 2 third signalings, then a first PUSCH of the plurality of PUSCHs may perform an uplink transmission on a first panel based on an SRI or a TCI state indicated by a first third signaling and a second PUSCH may perform an uplink transmission on a second panel based on an SRI or a TCI state indicated by a second third signaling.

In another implementation, the terminal device may receive 1 fourth signaling (for example, DCI or an RRC signaling), the fourth signaling is used to schedule a plurality of repeated transmissions of the PUSCH, and the plurality of repeated transmissions are transmitted simultaneously on different panels by using a same physical resource. The fourth signaling may indicate a plurality of SRIs or a plurality of TCI states, to determine transmitting beams and/or transmitting panels of a plurality of the scheduled PUSCHs. For example, a first PUSCH of the plurality of PUSCHs performs an uplink transmission on a first panel based on a first SRI or TCI state indicated by the fourth signaling, and a second PUSCH performs an uplink transmission on a second panel based on a second SRI or TCI state indicated by the fourth signaling.

It needs to be noted that, in the embodiments of the disclosure, the terminal device transmitting the UCI carried by the PUCCH on the target PUSCH may mean: the terminal device not transmitting the PUCCH, but transmitting the UCI carried by the PUCCH in the target PUSCH.

For example, for the case 1, the terminal device may transmit the UCI by multiplexing the UCI with data of one or more transport layers of the target PUSCH, or the terminal device may puncture (i.e., perform puncturing to) partial data or resource elements (REs) of one or more transport layers of the target PUSCH, for transmitting the UCI. These two methods are collectively referred to as a multiplexing transmission below.

For another example, for the case 2, the terminal device may transmit the UCI by multiplexing the UCI with data of one or more PUSCHs included in the target PUSCH, or the terminal device may puncture (i.e., perform puncturing to) partial data or REs of one or more PUSCHs included in the target PUSCH, for transmitting the UCI.

In the following, combined with the case 1 and the case 2, multiplexing methods of the UCI carried by the PUCCH on the target PUSCH are described respectively.

For the case 1: the target PUSCH includes one PUSCH, and different transport layers of the target PUSCH are transmitted based on different spatial relation information. For example, different transport layers of the target PUSCH are transmitted by a plurality of panels.

### Method 1:

The terminal device transmits the UCI on a first-type transport layer of the target PUSCH.

That is, the terminal device transmits the UCI only on the first-type transport layer of the target PUSCH and does not multiplex the UCI on other transport layers.

In other words, the terminal device multiplexes UCI with data of the first-type transport layer of the target PUSCH, but not with data of other transport layers.

Correspondingly, the network device receives the UCI on the first-type transport layer of the target PUSCH.

That is, the terminal device and the network device have a consistent understanding of the transport layer multiplexed by the UCI on the target PUSCH.

In some embodiments, the first-type transport layer is related to a transmission parameter of the PUCCH. That is, the first-type transport layer may be determined according to the transmission parameter of the PUCCH.

Optionally, the transmission parameter of the PUCCH may include but be not limited to spatial relation information of the PUCCH, an antenna panel associated with the PUCCH, a reference signal set associated with the PUCCH, etc.

In some embodiments, the spatial relation information of the PUCCH may be a TCI state indicated by DCI or an RRC signaling for scheduling the PUCCH, or PUCCH-spatialrelationinfo.

In some embodiments, the reference signal set associated with the PUCCH may refer to a reference signal set associated with an antenna panel used to transmit the PUCCH, or may be a reference signal set configured by the network device for the PUCCH.

In some embodiments, the antenna panel associated with the PUCCH may refer to an antenna panel used to transmit the PUCCH.

In some embodiments, the first-type transport layer being related to the transmission parameter of the PUCCH includes at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

In some embodiments, the reference signal may be an SSB, a CSI-RS or an SRS.

In some embodiments, the reference signal resource set may be a CSI-RS resource set, an SRS resource set, or an SSB set carrying a same PCI.

In some embodiments, the terminal device may receive a scheduling signaling (such as DCI or an RRC signaling, etc.) of the target PUSCH, the scheduling signaling is used to schedule different transport layers of the target PUSCH to be transmitted based on different spatial relation information, for example, the scheduling signaling may indicate the spatial relation information corresponding to different transport layers of the target PUSCH.

In some embodiments, the spatial relation information of the first-type transport layer may be an SRI corresponding to a first-type transport layer indicated by the DCI or RRC signaling for scheduling the target PUSCH, or a TCI state corresponding to the first-type transport layer indicated by the DCI or RRC signaling for scheduling the target PUSCH.

In some embodiments, the spatial relation information of the first-type transport layer and the spatial relation information of the PUCCH indicating the same reference signal may include:
an SRI corresponding to the first-type transport layer and the spatial relation information (e.g., an SRI or TCI state) of the PUCCH indicating a same SRS resource.

In some embodiments, the spatial relation information of the first-type transport layer and the spatial relation information of the PUCCH indicating the quasi-co-located reference signal, may include:
an SRS resource indicated by an SRI corresponding to the first-type transport layer and a CSI-RS resource indicated by the spatial relation information (such as an SRI or a TCI state) of the PUCCH being quasi-co-located, that is, a beam of the SRS resource being determined according to the CSI-RS resource.

In some embodiments, the spatial relation information of the first-type transport layer and the spatial relation information of the PUCCH indicating reference signals in a same reference signal resource set, includes:
a TCI state corresponding to the first-type transport layer and a TCI state of the PUCCH indicating CSI-RS resources in a same CSI-RS resource set.

For example, the TCI state corresponding to the first-type transport layer and the TCI state of the PUCCH may indicate a same CSI-RS resource or different CSI-RS resources in a same CSI-RS resource set.

In some embodiments, a correspondence between a transport layer of the target PUSCH and a reference signal set and a correspondence between the PUCCH and a reference signal set may be configured by the network device to the terminal device, or may also be notified to the network device via the terminal device by reporting a capability. That is, the network device and the terminal device have a consistent understanding of the correspondence between a transport layer of the target PUSCH and a reference signal set and the correspondence between the PUCCH and a reference signal set.

In some embodiments, a correspondence between a transport layer of the target PUSCH and a panel ID and a correspondence between the PUCCH and a panel ID may be configured by the network device to the terminal device, for example, the spatial relation information of the PUCCH may include indication information (such as a panel ID) of a panel associated with the PUCCH, or, the spatial relation information of the target PUSCH includes indication information (such as panel IDs) of panels associated with different transport layers of the target PUSCH. That is, the network device and the terminal device have a consistent understanding of the correspondence between a transport layer of the target PUSCH and a panel ID and the correspondence between the PUCCH and a panel ID.

### Method 2:

The terminal device transmits the UCI on a second-type transport layer of the target PUSCH.

That is, the terminal device transmits the UCI only on the second-type transport layer of the target PUSCH, and does not multiplex the UCI on other transport layers.

In other words, the terminal device multiplexes the UCI with data of the second-type transport layer of the target PUSCH, and not with data of other transport layers.

Correspondingly, the network device receives the UCI on the second-type transport layer of the target PUSCH.

That is, the terminal device and the network device have a consistent understanding of the transport layer multiplexed by the UCI on the target PUSCH.

In some embodiments, the second-type transport layer is a specific transport layer of the target PUSCH, for example, a first transport layer or a last transport layer of the target PUSCH.

In some other embodiments, the second-type transport layer is associated with a specific panel of the terminal device.

For example, the second-type transport layer is a transport layer transmitted on a first panel of the terminal device, or the second-type transport layer is a transport layer associated with a panel ID of 0. That is, the second-type transport layer is associated with a first panel of the terminal device or associated with a panel with a panel ID of 0.

It should be understood that, the second-type transport layer being associated with a specific panel of the terminal device, may mean the second-type transport layer being associated with a first transport layer transmitted on the specific panel, or may mean the second-type transport layer being associated with all transport layers transmitted on the specific panel.

In some further embodiments, the second-type transport layer is associated with a specific reference signal resource set.

For example, the second-type transport layer is a transport layer associated with a first reference signal resource set (e.g., a reference signal resource set with an index of 0).

It should be understood that, the second-type transport layer being associated with the specific reference signal resource set may mean, the second-type transport layer being associated with a first transport layer transmitted on the specific reference signal resource set, or mean the second-type transport layer being associated with all transport layers transmitted on the specific reference signal resource set.

Optionally, such a first reference signal resource set may be a first one of all reference signal resource sets configured on the terminal device.

### Method 3:

The terminal device transmits the UCI on all transport layers of the target PUSCH based on different spatial relation information.

That is, the terminal device does not need to determine the first-type transport layer or the second-type transport layer of the target PUSCH, but transmits the UCI on all transport layers of the target PUSCH. Herein, the UCI transmitted on all transport layers is transmitted based on different spatial relation information, such as different transmitting beams or different transmitting panels.

Correspondingly, the network device receives the UCI transmitted by the terminal device based on different spatial relation information, on all transport layers of the target PUSCH.

That is, the terminal device and the network device have a consistent understanding of the transport layers multiplexed by the UCI on the target PUSCH.

In some embodiments of the disclosure, the terminal device may determine the second-type transport layer using the above method 2 directly, and transmit the UCI on the second-type transport layer of the target PUSCH, or the terminal device may also first determine the first-type transport layer according to the method 1, and if there is the first-type transport layer satisfying a condition, the terminal device may transmit the UCI on the first-type transport layer of the target PUSCH, and if there isn't the first-type transport layer satisfying the condition, the terminal device may transmit the UCI on the second-type transport layer, or the terminal device may also transmit the UCI on all transport layers of the target PUSCH based on different spatial relation information, or the terminal device may not transmit the UCI on the target PUSCH, for example, transmit the UCI on the PUCCH still, or discard the UCI directly.

That is, the terminal device prioritizes to transmit the UCI on the first-type transport layer of the target PUSCH, and in a case where there isn't the first-type transport layer satisfying the condition, the terminal device transmits the UCI on the second-type transport layer of the target PUSCH, or transmits the UCI on all transport layers of the target PUSCH based on different spatial relation information, or does not transmit the UCI on the target PUSCH.

For the case 2: the target PUSCH includes a plurality of PUSCHs, and the plurality of PUSCHs are transmitted based on different spatial relation information.

For example, the plurality of PUSCHs included in the target PUSCH are transmitted through a plurality of panels. The transmission may be repeated transmissions of a PUSCH scheduled by a single DCI, or a multiplexed transmission of a plurality of PUSCHs scheduled by a plurality of DCIs.

Method 1: the terminal device transmits the UCI on a first PUSCH of a plurality of PUSCH included in the target PUSCH.

That is, the terminal device transmits the UCI only on the first PUSCH included in the target PUSCH, and does not multiplex the UCI on other PUSCHs.

In other words, the terminal device multiplexes the DCI with data of the first PUSCH in the target PUSCH, and not with data of other PUSCHs.

Correspondingly, the network device receives the UCI on the first PUSCH of the target PUSCH.

That is, the terminal device and the network device have a consistent understanding of the PUSCH multiplexed by the UCI on the target PUSCH.

In some embodiments, the first PUSCH is related to a transmission parameter of the PUCCH. That is, the first PUSCH is determined according to the transmission parameter of the PUCCH.

Optionally, the transmission parameter of the PUCCH may include but be not limited to spatial relation information of the PUCCH, an antenna panel used to transmit the PUCCH, a reference signal set associated with the PUCCH, a CORESET group associated with the PUCCH, etc.

In some embodiments, the spatial relation information of the PUCCH may be a TCI state or PUCCH-spatialrelationinfo indicated by DCI or an RRC signaling for scheduling the PUCCH.

In some embodiments, the reference signal set associated with the PUCCH may refer to a reference signal set associated with an antenna panel used to transmit the PUCCH, or may be a reference signal set configured by the network device for the PUCCH.

In some embodiments, the CORESET group associated with the PUCCH may refer to a CORESET group to which a CORESET, where a physical downlink control channel (PDCCH) for scheduling the PUCCH is located, belongs.

In some embodiments, the first PUSCH being related to the transmission parameter of the PUCCH, includes at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

In some embodiments, the spatial relation information of the first PUSCH may be an SRI indicated by DCI or an RRC signaling for scheduling the first PUSCH, or a TCI state indicated by DCI or an RRC signaling for scheduling the first PUSCH.

In some embodiments, the spatial relation information of the first PUSCH and the spatial relation information of the PUCCH indicating the same reference signal, includes: an SRI corresponding to the first PUSCH and the spatial relation information (such as an SRI or a TCI state) of the PUCCH indicating a same SRS resource.

In some embodiments, the spatial relation information of the first PUSCH and the spatial relation information of the PUCCH indicating the quasi-co-located reference signal, includes: an SRS resource indicated by an SRI corresponding to the first PUSCH and a CSI-RS resource indicated by the spatial relation information of the PUCCH are quasi-co-located, that is, a beam of the SRS resource is determined according to the CSI-RS resource.

In some embodiments, the spatial relation information of the first PUSCH and the spatial relation information of the PUCCH indicating reference signals in the same reference signal resource set, includes: a TCI state corresponding to the first PUSCH and a TCI state of the PUCCH indicating CSI-RS resources in a same CSI-RS resource set. For example, a TCI state corresponding to the first PUSCH and a TCI state of the PUCCH may indicate a same CSI-RS resource or different CSI-RS resources in a same CSI-RS resource set.

In some embodiments, a correspondence between a plurality of PUSCHs included in the target PUSCH and a reference signal set and a correspondence between the PUCCH and a reference signal set may be configured by the network device to the terminal device, or may also be notified to the network device via the terminal device by reporting a capability. That is, the network device and the terminal device have a consistent understanding of the correspondence between a plurality of PUSCHs included in the target PUSCH and a reference signal set and the correspondence between the PUCCH and a reference signal set.

In some embodiments, a correspondence between a plurality of PUSCHs included in the target PUSCH and a panel ID and a correspondence between the PUCCH and a panel ID may be configured by the network device to the terminal device. For example, the spatial relation information of the PUCCH may include indication information (such as a panel ID) of a panel associated with the PUCCH. Spatial relation information of each PUSCH in the target PUSCH includes indication information (for example, a panel ID) of a panel associated with the each PUSCH. That is, the network device and the terminal device have a consistent understanding of the correspondence between each PUSCH in the target PUSCH and a panel ID and the correspondence between the PUCCH and a panel ID.

In some embodiments, a CORESET pool index associated with the first PUSCH may be a CORESET pool index configured by a CORESET where a physical downlink control channel (PDCCH) for scheduling the first PUSCH is located; a CORESET pool index associated with the PUCCH may be a CORESET pool index configured by a CORESET where the PDCCH for triggering the PUCCH is located, or a CORESET pool index configured by a high-layer signaling for a PUCCH resource of the PUCCH.

### Method 2:

The terminal device transmits the UCI on a second PUSCH of a plurality of PUSCHs included in the target PUSCH.

That is, the terminal device transmits the UCI only on the second PUSCH of the target PUSCH, and does not multiplex the UCI on other PUSCHs.

In other words, the terminal device multiplexes the DCI with data of the second PUSCH of the target PUSCH and not with data of other PUSCHs.

Correspondingly, the network device receives the UCI on the second PUSCH of the target PUSCH.

That is, the terminal device and the network equipment have a consistent understanding of the PUSCH multiplexed by the UCI on the target PUSCH.

In some embodiments, the second PUSCH is a specific PUSCH in the target PUSCH.

For example, the second PUSCH is a PUSCH starting to be transmitted at the earliest among the plurality of PUSCHs included in the target PUSCH.

Optionally, the second PUSCH being a PUSCH starting to be transmitted at the earliest among the plurality of PUSCHs may mean that the second PUSCH has the earliest starting time, for example, the earliest starting symbol, among the plurality of PUSCHs.

For another example, the second PUSCH is a PUSCH scheduled at the earliest among the plurality of PUSCHs.

Optionally, the second PUSCH being a PUSCH scheduled at the earliest among the plurality of PUSCHs may mean that a PDCCH of the second PUSCH has the earliest starting time among PDCCHs for scheduling the plurality of PUSCHs.

For further example, the second PUSCH may also be a PUSCH last scheduled among the plurality of PUSCHs.

In some other embodiments, the second PUSCH is associated with a specific panel of the terminal device.

For example, the second PUSCH is a PUSCH transmitted on a first antenna panel of the terminal device. That is, the second PUSCH is associated with a first panel of the terminal device.

For another example, the second PUSCH is a PUSCH associated with a panel ID of 0. That is, the second PUSCH is associated with a panel with a panel ID of 0.

For further example, the second PUSCH may also be a PUSCH associated with a panel ID of 1. That is, the second PUSCH is associated with a panel with a panel ID of 1.

In some further embodiments, the second PUSCH is associated with a specific reference signal resource set, or associated with a specific CORESET group.

For example, the second PUSCH is a PUSCH associated with a first reference signal resource set.

For another example, the second PUSCH is a PUSCH associated with a CORESET pool index of 0. Optionally, in the embodiments of the disclosure, the PUSCH associated with the specific reference signal resource set may refer to a PUSCH transmitted by a panel corresponding to the reference signal resource set.

In some embodiments, the terminal device may also determine a PUSCH used to transmit the UCI according to modulation and coding schemes (MCSs) of the plurality of PUSCHs.

For example, the terminal device may determine a PUSCH used to transmit the UCI according to MCS levels of the plurality of PUSCHs. A PUSCH with a highest MCS level among the plurality of PUSCHs may be selected for the uplink transmission of the UCI. That is, the terminal device may transmit the UCI carried by the PUCCH on the PUSCH with the highest MCS level. Selecting the PUSCH according to the MCS level to transmit the UCI may ensure the transmission with higher reliability.

Method 3: the terminal device transmits the UCI on the plurality of PUSCHs based on different spatial relation information simultaneously.

That is, the terminal device does not need to determine a first PUSCH or a second PUSCH of the target PUSCH, but transmits the UCI on all PUSCHs included in the target PUSCH. Herein, the UCI transmitted on all PUSCHs is transmitted based on different spatial relation information, such as different transmitting beams or different transmitting panels.

Correspondingly, the network device receives the UCI transmitted by the terminal device based on different spatial relation information, on all PUSCHs of the target PUSCH.

That is, the terminal device and the network device have a consistent understanding of the PUSCH multiplexed by the UCI on the target PUSCH.

In some embodiments, the terminal device may directly determine the second PUSCH using the method 2 and transmit the UCI on the second PUSCH, or the terminal device may also first determine the first PUSCH according to the method 1, and if there is the first PUSCH satisfying a condition, the terminal device may transmit the UCI on the first PUSCH of the target PUSCH, and if there isn't the first PUSCH satisfying the condition, transmit the UCI on the second PUSCH, or the terminal device may transmit the UCI on all PUSCHs included in the target PUSCH based on different spatial relation information, or the terminal device may not transmit the UCI on any PUSCH in the target PUSCH, for example, the terminal device may transmit the UCI on the PUCCH still, or discard the UCI directly.

That is, the terminal device prioritizes to transmit the UCI on the first PUSCH of the target PUSCH, and if there isn't the first PUSCH satisfying the condition, the terminal device transmits the UCI on the second PUSCH in the target PUSCH, or transmits the UCI on all PUSCHs of the target PUSCH based on different spatial relation information, or does not transmit the UCI on any PUSCH in the target PUSCH.

In some other embodiments, the terminal device determines a PUSCH used to transmit the UCI among a plurality of PUSCHs, according to whether the plurality of PUSCHs transmit same TBs.

For example, if the plurality of PUSCHs transmit different TBs, the UCI is transmitted on the first PUSCH of the plurality of PUSCHs, or the UCI is transmitted on the second PUSCH of the plurality of PUSCHs, that is, the method 1 or the method 2 is used for the multiplexed transmission of the UCI on the PUSCH. If the plurality of PUSCHs transmit same TBs, the UCI is transmitted simultaneously on the plurality of PUSCHs based on different spatial relation information. For example, the UCI is transmitted simultaneously on the plurality of PUSCHs based on different transmitting beams or transmitting panels.

For another example, if the plurality of PUSCHs transmit different TBs, the UCI is transmitted on the first PUSCH of the plurality of PUSCHs, that is, the method 1 is used for the multiplexed transmission of the UCI on the PUSCH. If the plurality of PUSCHs transmit same TBs, the UCI is transmitted on the second PUSCH in the plurality of PUSCHs, that is, the method 2 is used for the multiplexed transmission of the UCI on the PUSCH.

In conclusion, for the transmission of a single PUSCH based on a plurality of panels and scheduled by a single DCI, the terminal device may multiplex the UCI onto only partial transport layers of the PUSCH (such as the first-type transport layer or the second-type transport layer), or multiplex the UCI onto all transport layers of the PUSCH.

For the transmission of a plurality of PUSCHs based on a plurality of panels and scheduled by a plurality of DCIs (or a single DCI), the terminal device may multiplex the UCI onto only partial PUSCHs (such as the first PUSCH or the second PUSCH) of the plurality of PUSCHs, or multiplex the UCI onto all PUSCHs of the plurality of PUSCHs.

Therefore, in the embodiments of the disclosure, the terminal device may determine a transport layer or a PUSCH multiplexed by the UCI based on the UCI and spatial relation information configuration of the PUSCH, thereby supporting the multiplexing of the UCI on the PUSCH transmission based on a plurality of panels and scheduled by a single DCI or a plurality of DCI.

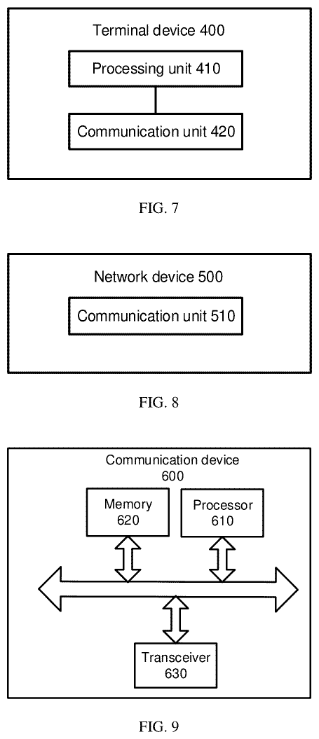

The method embodiments of the disclosure have been described in detail above with reference to FIG. 6, and apparatus embodiments of the disclosure are described in detail below with reference to FIG. 7 to FIG. 11. It should be understood that the apparatus embodiments and the method embodiments correspond to each other and the similar description may refer to the method embodiments.

FIG. 7 illustrates a schematic block diagram of a terminal device 400 according to the embodiments of the disclosure. As shown in FIG. 7, the terminal device 400 includes:
a processing unit 410, configured to determine that a physical uplink control channel (PUCCH) and a target physical uplink shared channel (PUSCH) are to be transmitted on a same time domain resource unit, where different transport layers of the target PUSCH are transmitted based on different spatial relation information, or the target PUSCH includes a plurality of PUSCHs transmitted simultaneously based on different spatial relation information;
a communication unit 420, configured to transmit uplink control information (UCI) carried by the PUCCH on the target PUSCH.

In some embodiments of the disclosure, different transport layers of the target PUSCH are transmitted based on different spatial relation information, and the communication unit 420 is further configured to:
transmit the UCI on all transport layers of the target PUSCH based on different spatial relation information; or
transmit the UCI on a first-type transport layer of the target PUSCH, where the first-type transport layer is related to a transmission parameter of the PUCCH; or
transmit the UCI on a second-type transport layer of the target PUSCH,
where the second-type transport layer is a first transport layer of the target PUSCH, or
the second-type transport layer is a transport layer transmitted on a first antenna panel of the terminal device, or
the second-type transport layer is a transport layer with an associated antenna panel identifier of 0, or
the second-type transport layer is a transport layer associated with a first reference signal resource set.

In some embodiments of the disclosure, the first-type transport layer being related to the transmission parameter of the PUCCH, includes at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

In some embodiments of the disclosure, the communication unit 420 is further configured to:
prioritize to transmit the UCI on the first-type transport layer of the target PUSCH;
in a case where there isn't the first-type transport layer satisfying a condition, transmit the UCI on the second-type transport layer of the target PUSCH, or transmit the UCI on all transport layers of the target PUSCH based on different spatial relation information.

In some embodiments of the disclosure, the target PUSCH includes a plurality of PUSCHs transmitted simultaneously based on different spatial relation information, and the communication unit 420 is further configured to:
transmit the UCI on the plurality of PUSCHs simultaneously based on different spatial relation information; or
transmit the UCI on a first PUSCH of the plurality of PUSCHs, where the first PUSCH is related to a transmission parameter of the PUCCH; or
transmit the UCI on a second PUSCH of the plurality of PUSCHs,
where the second PUSCH is a PUSCH transmitted on a first antenna panel of the terminal device, or
the second PUSCH is a PUSCH with an associated antenna panel identifier of 0, or
the second PUSCH is a PUSCH associated with a first reference signal resource set, or
the second PUSCH is a PUSCH with an associated control resource set (CORESET) pool index of 0, or
the second PUSCH is a PUSCH starting to be transmitted at the earliest among the plurality of PUSCHs, or
the second PUSCH is a PUSCH scheduled at the earliest among the plurality of PUSCHs; or
the second PUSCH is a PUSCH with a highest modulation and coding scheme (MCS) level among the plurality of PUSCHs.

In some embodiments of the disclosure, the first PUSCH being related to the transmission parameter of the PUCCH, includes at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

In some embodiments of the disclosure, the communication unit 420 is further configured to:
prioritize to transmit the UCI on the first PUSCH;
in a case where there isn't the first PUSCH satisfying a condition, transmit, the UCI on the second PUSCH, or transmit the UCI on the plurality of PUSCHs simultaneously based on different spatial relation information.

In some embodiments of the disclosure, the processing unit 410 is further configured to:
determine a PUSCH used to transmit the UCI among the plurality of PUSCHs, according to whether the plurality of PUSCHs transmit same transport blocks.

In some embodiments of the disclosure, the communication unit 420 is further configured to:
if the plurality of PUSCHs transmit different transport blocks, transmit the UCI on the first PUSCH of the plurality of PUSCHs, or transmit the UCI on the second PUSCH of the plurality of PUSCHs; and/or,
if the plurality of PUSCHs transmit the same transport blocks, transmit the UCI on the plurality of PUSCHs simultaneously based on different spatial relation information.

In some embodiments of the disclosure, different transport layers of the target PUSCH are transmitted on different antenna panels based on different spatial relation information;
the plurality of PUSCHs included in the target PUSCH are transmitted simultaneously on different antenna panels based on different spatial relation information.

In some embodiments of the disclosure, the reference signal resource set is a channel state information reference signal (CSI-RS) resource set, or a sounding reference signal (SRS) resource set, or a synchronization signal block (SSB) set carrying a same physical cell identifier (PCI).

In some embodiments of the disclosure, the spatial relation information is a sounding reference signal resource indicator (SRI), or physical uplink control channel (PUCCH) spatial relation information or a transmission configuration indicator (TCI) state.

In some embodiments of the disclosure, the time domain resource unit is a slot, a sub-slot, or an orthogonal frequency division multiplexing (OFDM) symbol.

Optionally, in some embodiments, the above communication unit may be a communication interface or a transceiver, or an input/output interface of a communication chip or a system-on-chip. The above processing unit may be one or more processors.

It should be understood that the terminal device 400 according to the embodiments of the disclosure may correspond to the terminal device of the method embodiments of the disclosure, and the above and other operations and/or functions of various units in the terminal device 400 are respectively to implement the corresponding procedure of the terminal device in the method 200 shown in FIG. 6, which will not be repeated here for the sake of brevity.

FIG. 8 is a schematic block diagram of a network device according to the embodiments of the disclosure. The network device 500 of FIG. 8 includes:
a communication unit 510, configured to schedule a physical uplink control channel (PUCCH) and a target physical uplink shared channel (PUSCH) to be transmitted on a same time domain resource unit, where different transport layers of the target PUSCH are transmitted based on different spatial relation information, or the target PUSCH includes a plurality of PUSCHs transmitted simultaneously based on different spatial relation information; and
receive uplink control information (UCI) carried by the PUCCH, transmitted by a terminal device on the target PUSCH.

In some embodiments of the disclosure, different transport layers of the target PUSCH are transmitted based on different spatial relation information, and the communication unit 510 is further configured to:
receive, the UCI transmitted by the terminal device on all transport layers of the target PUSCH based on different spatial relation information; or
receive, the UCI on a first-type transport layer of the target PUSCH, where the first-type transport layer is related to a transmission parameter of the PUCCH; or
receive, the UCI on a second-type transport layer of the target PUSCH,
where the second-type transport layer is a first transport layer of the target PUSCH, or
the second-type transport layer is a transport layer transmitted on a first antenna panel of the terminal device, or
the second-type transport layer is a transport layer with an associated antenna panel identifier of 0, or
the second-type transport layer is a transport layer associated with a first reference signal resource set.

In some embodiments of the disclosure, the first-type transport layer being related to the transmission parameter of the PUCCH, includes at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

In some embodiments of the disclosure, the communication unit 510 is further configured to:
prioritize to receive the UCI on the first-type transport layer of the target PUSCH;
in a case where there isn't the first-type transport layer satisfying a condition, receive the UCI on the second-type transport layer of the target PUSCH, or receive the UCI transmitted simultaneously by the terminal device on all transport layers of the target PUSCH based on different spatial relation information.

In some embodiments of the disclosure, the target PUSCH includes a plurality of PUSCHs transmitted simultaneously based on different spatial relation information, and the communication unit 510 is further configured to:
receive, the UCI simultaneously transmitted by the terminal device on the plurality of PUSCHs based on different spatial relation information; or
receive, the UCI on a first PUSCH of the plurality of PUSCHs, where the first PUSCH is related to a transmission parameter of the PUCCH; or
receive, the UCI on a second PUSCH of the plurality of PUSCHs,
where the second PUSCH is a PUSCH transmitted on a first antenna panel of the terminal device;
the second PUSCH is a PUSCH with an associated antenna panel identifier of 0;
the second PUSCH is a PUSCH associated with a first reference signal resource set;
the second PUSCH is a PUSCH with an associated control resource set (CORESET) pool index of 0;
the second PUSCH is a PUSCH starting to be transmitted at the earliest among the plurality of PUSCHs;
the second PUSCH is a PUSCH scheduled at the earliest among the plurality of PUSCHs;
the second PUSCH is a PUSCH with a highest modulation and coding scheme (MCS) level among the plurality of PUSCHs.

In some embodiments of the disclosure, the first PUSCH being related to the transmission parameter of the PUCCH, includes at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

In some embodiments of the disclosure, the communication unit 510 is further configured to:
prioritize to receive by the network device, the UCI on the first PUSCH;
in a case where there isn't the first PUSCH satisfying a condition, receive the UCI on the second PUSCH, or receive the UCI simultaneously transmitted by the terminal device on the plurality of PUSCHs based on different spatial relation information.

In some embodiments of the disclosure, the network device 500 further includes: a processing unit, configured to determine a PUSCH used to receive the UCI among the plurality of PUSCHs, according to whether the plurality of PUSCHs transmit same transport blocks.

In some embodiments of the disclosure, the processing unit is further configured to:
if the plurality of PUSCHs transmit different transport blocks, receive the UCI on the first PUSCH of the plurality of PUSCHs, or receive the UCI on the second PUSCH of the plurality of PUSCHs; and/or
if the plurality of PUSCHs transmit the same transport blocks, receive the UCI simultaneously transmitted by the terminal device on the plurality of PUSCHs based on different spatial relation information.

In some embodiments of the disclosure, different transport layers of the target PUSCH are transmitted on different antenna panels based on different spatial relation information;
the plurality of PUSCHs included in the target PUSCH are transmitted simultaneously on different antenna panels based on different spatial relation information.

In some embodiments of the disclosure, the reference signal resource set is a channel state information reference signal (CSI-RS) resource set, or a sounding reference signal (SRS) resource set, or a synchronization signal block (SSB) set carrying a same physical cell identifier (PCI).

In some embodiments of the disclosure, the spatial relation information is a sounding reference signal resource indicator (SRI), or a physical uplink control channel (PUCCH) spatial relation information or a transmission configuration indicator (TCI) state.

In some embodiments of the disclosure, the time domain resource unit is a slot, a sub-slot, or an orthogonal frequency division multiplexing (OFDM) symbol.

Optionally, in some embodiments, the above communication unit may be a communication interface or a transceiver, or an input/output interface of a communication chip or a system-on-chip. The above processing unit may be one or more processors.

It should be understood that, the network device 500 according to the embodiments of the disclosure may correspond to the network device of the method embodiments of the disclosure, and the above and other operations and/or functions of various units in the network device 500 are respectively to implement the corresponding procedure of the network device in the method 200 shown in FIG. 6, which will not be repeated here for the sake of brevity.

FIG. 9 is a schematic structural diagram of a communication device 600, provided by the embodiments of the disclosure. The communication device 600 shown in FIG. 9 includes a processor 610. The processor 610 may invoke and execute a computer program from a memory to implement the method in the embodiments of the disclosure.

Optionally, as shown in FIG. 9, the communication device 600 may further include a memory 620. Herein, the processor 610 may invoke and execute a computer program from the memory 620 to implement the method in the embodiments of the disclosure.

Herein, the memory 620 may be a separate device independent from the processor 610, or may also be integrated into the processor 610.

Optionally, as shown in FIG. 9, the communication device 600 may also include a transceiver 630, and the processor 610 may control the transceiver 630 to communicate with other devices, and specifically, the transceiver 630 may send information or data to other devices, or receive information or data sent by other devices.

Herein, the transceiver 630 may include a transmitter and a receiver. The transceiver 630 may further include antennas, and the number of antennas may be one or more.

Optionally, the communication device 600 may specifically be the network device of the embodiments of the disclosure, and the communication device 600 may implement the corresponding procedure implemented by the network device in the various methods of the embodiments of the disclosure, which will not be repeated here for the sake of brevity.

Optionally, the communication device 600 may specifically be the mobile terminal/terminal device of the embodiments of the disclosure, and the communication device 600 may implement the corresponding procedures implemented by the mobile terminal/terminal device in the various methods of the embodiments of the disclosure, which will not be repeated here for the sake of brevity.

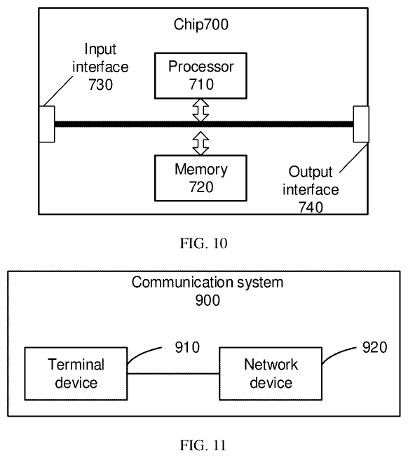

FIG. 10 is a schematic structural diagram of a chip of the embodiments of the disclosure. The chip 700 shown in FIG. 10 includes a processor 710, the processor 710 may invoke and execute a computer program from a memory to implement the method in the embodiments of the disclosure.

Optionally, as shown in FIG. 10, the chip 700 may further include a memory 720. Herein, the processor 710 may invoke and execute a computer program from the memory 720 to implement the method in the embodiments of the disclosure.

Herein, the memory 720 may be a separate device independent from the processor 710, or may also be integrated into the processor 710.

Optionally, the chip 700 may further include an input interface 730. Herein, the processor 710 may control the input interface 730 to communicate with other devices or chips, and specifically, the input interface 730 may acquire information or data sent by other devices or chips.

Optionally, the chip 700 may further include an output interface 740. Herein, the processor 710 may control the output interface 740 to communicate with other devices or chips, and specifically, the output interface 740 may output information or data to other devices or chips.

Optionally, the chip may be applied to the network device in the embodiments of the disclosure, and the chip may implement the corresponding procedure implemented by the network device in the various methods of the embodiments of the disclosure, which will not be repeated here for the sake of brevity.

Optionally, the chip may be applied to the mobile terminal/terminal device in the embodiments of the disclosure, and the chip may implement the corresponding procedure implemented by the mobile terminal/terminal device in the various methods of the embodiments of the disclosure, which will not be repeated here for the sake of brevity.

It should be understood that, the chip mentioned in the embodiments of the disclosure may also be referred to as a system on chip, a system chip, a chip system or a system-on-chip chip, etc.

FIG. 11 is a schematic block diagram of a communication system 900, provided by the embodiments of the disclosure. As shown in FIG. 11, the communication system 900 includes a terminal device 910 and a network device 920.

Herein, the terminal device 910 may be used to implement the corresponding functions implemented by the terminal device in the above method, and the network device 920 may be used to implement the corresponding functions implemented by the network device in the above method, which will not be repeated here for the sake of brevity.

It should be understood that, the processor in the embodiments of the disclosure may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the disclosure may be implemented or performed. A general-purpose processor may be a microprocessor, or the processor may also be any conventional processor, etc. The steps of the method disclosed in combination with the embodiments of the disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the disclosure may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that, the memory of the system and the method described herein is intended to include, but not limited to, these and any other suitable types of memories.

It should be understood that, the above memory is exemplary but not limiting illustration, e.g., the memory in embodiments of the disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the disclosure is intended to include, but not limited to, these and any other suitable types of memories.

The embodiments of the disclosure further provide a non-transitory computer readable storage medium for storing a computer program.

Optionally, the non-transitory computer readable storage medium may be applied to the network device in the embodiments of the disclosure, and the computer program causes a computer to perform the corresponding procedure implemented by the network device in the various methods of the embodiments of the disclosure, which will not be repeated here for the sake of brevity.

Optionally, the non-transitory computer readable storage medium may be applied to the mobile terminal/terminal device in the embodiments of the disclosure, and the computer program causes a computer to perform the corresponding procedure implemented by the mobile terminal/terminal device in various methods of the embodiments of the disclosure, which will not be repeated here for the sake of brevity.

The embodiments of the disclosure further provide a computer program product including a computer program instruction.

Optionally, the computer program product may be applied to the network device in the embodiments of the disclosure, and the computer program instruction causes a computer to perform the corresponding procedure implemented by the network device in the various methods of the embodiments of the disclosure, which will not be repeated here for the sake of brevity.

Optionally, the computer program product may be applied to the mobile terminal/terminal device in the embodiments of the disclosure, and the computer program instruction cause a computer to perform the corresponding procedure implemented by the mobile terminal/terminal device in various methods of the embodiments of the disclosure, which will not be repeated here for the sake of brevity.

The embodiments of the disclosure further provide a computer program.

Optionally, the computer program may be applied to the network device in the embodiments of the disclosure, the computer program when being executed on a computer, causes the computer to perform the corresponding procedure implemented by the network device in various methods of the embodiments of the disclosure, which will not be repeated here for the sake of brevity.

Optionally, the computer program may be applied to the mobile terminal/terminal device in the embodiments of the disclosure, the computer program when being executed on a computer, causes the computer to perform the corresponding procedure implemented by the mobile terminal/terminal device in various methods of the embodiments of the disclosure, which will not be repeated here for the sake of brevity.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the disclosure.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the disclosure may be integrated into one processing unit, or the various units may exist physically separately, or two or more units may be integrated into one unit.

If the described functions are implemented in a form of a software functional unit and sold or used as an independent product, they may be stored in a non-transitory computer readable storage medium. Based on this understanding, the technical solution of the disclosure essentially, or a part of the technical solution that contributes to the prior art, or a part of the technical solution, may be embodied in a form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the disclosure. And, the non-transitory storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the disclosure, but the protection scope of the disclosure is not limited thereto, and any skilled familiar with this technical field may easily think of changes or substitutions within the technical scope disclosed in the disclosure, which should be all covered within the protection scope of the disclosure. Therefore, the protection scope of the disclosure should be subject to the protection scope of the claims.

What is claimed is:

1. A method of wireless communication, comprising:
determining by a terminal device, that a physical uplink control channel (PUCCH) and a target physical uplink shared channel (PUSCH) are to be transmitted on a same time domain resource unit, wherein different transport layers of the target PUSCH are transmitted based on different spatial relation information, or the target PUSCH comprises a plurality of PUSCHs transmitted simultaneously based on different spatial relation information;
transmitting by the terminal device, uplink control information (UCI) carried by the PUCCH on the target PUSCH.

2. The method according to claim 1, wherein different transport layers of the target PUSCH are transmitted based on different spatial relation information, transmitting by the terminal device, the UCI carried by the PUCCH on the target PUSCH, comprises:
transmitting by the terminal device, the UCI on all transport layers of the target PUSCH based on different spatial relation information; or
transmitting by the terminal device, the UCI on a first-type transport layer of the target PUSCH, wherein the first-type transport layer is related to a transmission parameter of the PUCCH; or
transmitting by the terminal device, the UCI on a second-type transport layer of the target PUSCH,
wherein the second-type transport layer is a first transport layer of the target PUSCH, or
the second-type transport layer is a transport layer transmitted on a first antenna panel of the terminal device, or
the second-type transport layer is a transport layer with an associated antenna panel identifier of 0, or
the second-type transport layer is a transport layer associated with a first reference signal resource set.

3. The method according to claim 2, wherein the first-type transport layer being related to the transmission parameter of the PUCCH, comprises at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

4. The method according to claim 1, wherein the target PUSCH comprises a plurality of PUSCHs transmitted simultaneously based on different spatial relation information, transmitting by the terminal device, the UCI carried by the PUCCH on the target PUSCH, comprises:
transmitting by the terminal device, the UCI on the plurality of PUSCHs simultaneously based on different spatial relation information; or
transmitting by the terminal device, the UCI on a first PUSCH of the plurality of PUSCHs, wherein the first PUSCH is related to a transmission parameter of the PUCCH; or
transmitting by the terminal device, the UCI on a second PUSCH of the plurality of PUSCHs,
wherein the second PUSCH is a PUSCH transmitted on a first antenna panel of the terminal device, or
the second PUSCH is a PUSCH with an associated antenna panel identifier of 0, or
the second PUSCH is a PUSCH associated with a first reference signal resource set, or
the second PUSCH is a PUSCH with an associated control resource set (CORESET) pool index of 0, or
the second PUSCH is a PUSCH starting to be transmitted at the earliest among the plurality of PUSCHs, or
the second PUSCH is a PUSCH scheduled at the earliest among the plurality of PUSCHs; or
the second PUSCH is a PUSCH with a highest modulation and coding scheme (MCS) level among the plurality of PUSCHs.

5. The method according to claim 4, wherein the first PUSCH being related to the transmission parameter of the PUCCH, comprises at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

6. The method according to claim 1, wherein different transport layers of the target PUSCH are transmitted on different antenna panels based on different spatial relation information;
the plurality of PUSCHs comprised in the target PUSCH are transmitted simultaneously on different antenna panels based on different spatial relation information.

7. The method according to claim 1, wherein the time domain resource unit is a slot, a sub-slot, or an orthogonal frequency division multiplexing (OFDM) symbol.

8. A method of wireless communication, comprising:
scheduling by a network device, a physical uplink control channel (PUCCH) and a target physical uplink shared channel (PUSCH) to be transmitted on a same time domain resource unit, wherein different transport layers of the target PUSCH are transmitted based on different spatial relation information, or the target PUSCH comprises a plurality of PUSCHs transmitted simultaneously based on different spatial relation information;
receiving by the network device, uplink control information (UCI) carried by the PUCCH, transmitted by a terminal device on the target PUSCH.

9. The method according to claim 8, wherein different transport layers of the target PUSCH are transmitted based on different spatial relation information, receiving by the network device, the UCI carried by the PUCCH, transmitted by the terminal device on the target PUSCH, comprises:
receiving by the network device, the UCI transmitted by the terminal device on all transport layers of the target PUSCH based on different spatial relation information; or
receiving by the network device, the UCI on a first-type transport layer of the target PUSCH, wherein the first-type transport layer is related to a transmission parameter of the PUCCH; or
receiving by the network device, the UCI on a second-type transport layer of the target PUSCH,
wherein the second-type transport layer is a first transport layer of the target PUSCH, or
the second-type transport layer is a transport layer transmitted on a first antenna panel of the terminal device, or
the second-type transport layer is a transport layer with an associated antenna panel identifier of 0, or
the second-type transport layer is a transport layer associated with a first reference signal resource set.

10. The method according to claim 8, wherein the target PUSCH comprises a plurality of PUSCHs transmitted simultaneously based on different spatial relation information, receiving by the network device, the UCI carried by the PUCCH, transmitted by the terminal device on the target PUSCH, comprises:
receiving by the network device, the UCI simultaneously transmitted by the terminal device on the plurality of PUSCHs based on different spatial relation information; or
receiving by the network device, the UCI on a first PUSCH of the plurality of PUSCHs, wherein the first PUSCH is related to a transmission parameter of the PUCCH; or
receiving by the network device, the UCI on a second PUSCH of the plurality of PUSCHs,
wherein the second PUSCH is a PUSCH transmitted on a first antenna panel of the terminal device; or
the second PUSCH is a PUSCH with an associated antenna panel identifier of 0; or
the second PUSCH is a PUSCH associated with a first reference signal resource set; or
the second PUSCH is a PUSCH with an associated control resource set (CORESET) pool index of 0; or
the second PUSCH is a PUSCH starting to be transmitted at the earliest among the plurality of PUSCHs; or
the second PUSCH is a PUSCH scheduled at the earliest among the plurality of PUSCHs; or
the second PUSCH is a PUSCH with a highest modulation and coding scheme (MCS) level among the plurality of PUSCHs.

11. The method according to claim 10, wherein the first PUSCH being related to the transmission parameter of the PUCCH, comprises at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

12. The method according to claim 8, wherein different transport layers of the target PUSCH are transmitted on different antenna panels based on different spatial relation information;
the plurality of PUSCHs comprised in the target PUSCH are transmitted simultaneously on different antenna panels based on different spatial relation information.

13. The method according to claim 8, wherein the time domain resource unit is a slot, a sub-slot, or an orthogonal frequency division multiplexing (OFDM) symbol.

14. A terminal device, comprising:
a transceiver,
a memory for storing a computer program, and
a processor configured to invoke and execute the computer program stored in the memory; wherein
the processor is configured to perform:
determining that a physical uplink control channel (PUCCH) and a target physical uplink shared channel (PUSCH) are to be transmitted on a same time domain resource unit, wherein different transport layers of the target PUSCH are transmitted based on different spatial relation information, or the target PUSCH comprises a plurality of PUSCHs transmitted simultaneously based on different spatial relation information; and
the transceiver is configured to perform:
transmitting uplink control information (UCI) carried by the PUCCH on the target PUSCH.

15. The terminal device according to claim 14, wherein different transport layers of the target PUSCH are transmitted based on different spatial relation information, and the transceiver is configured to perform:
transmitting the UCI on all transport layers of the target PUSCH based on different spatial relation information; or
transmitting the UCI on a first-type transport layer of the target PUSCH, wherein the first-type transport layer is related to a transmission parameter of the PUCCH; or
transmitting the UCI on a second-type transport layer of the target PUSCH,
wherein the second-type transport layer is a first transport layer of the target PUSCH, or
the second-type transport layer is a transport layer transmitted on a first antenna panel of the terminal device, or
the second-type transport layer is a transport layer with an associated antenna panel identifier of 0, or
the second-type transport layer is a transport layer associated with a first reference signal resource set.

16. The terminal device according to claim 15, wherein the first-type transport layer being related to the transmission parameter of the PUCCH, comprises at least one of:
spatial relation information of the first-type transport layer and spatial relation information of the PUCCH indicating a same reference signal;
the spatial relation information of the first-type transport layer and the spatial relation information of the PUCCH indicating a quasi-co-located reference signal;
the spatial relation information of the first-type transport layer and the spatial relation information of the PUCCH indicating reference signals in a same reference signal resource set;
the first-type transport layer and the PUCCH being associated with a same reference signal set; or
the first-type transport layer and the PUCCH being associated with a same antenna panel identifier.

17. The terminal device according to claim 14, wherein the target PUSCH comprises a plurality of PUSCHs transmitted simultaneously based on different spatial relation information, and the transceiver is configured to perform:
transmitting the UCI on the plurality of PUSCHs simultaneously based on different spatial relation information; or
transmitting the UCI on a first PUSCH of the plurality of PUSCHs, wherein the first PUSCH is related to a transmission parameter of the PUCCH; or
transmitting the UCI on a second PUSCH of the plurality of PUSCHs,
wherein the second PUSCH is a PUSCH transmitted on a first antenna panel of the terminal device, or
the second PUSCH is a PUSCH with an associated antenna panel identifier of 0, or
the second PUSCH is a PUSCH associated with a first reference signal resource set, or
the second PUSCH is a PUSCH with an associated control resource set (CORESET) pool index of 0, or
the second PUSCH is a PUSCH starting to be transmitted at the earliest among the plurality of PUSCHs, or
the second PUSCH is a PUSCH scheduled at the earliest among the plurality of PUSCHs; or
the second PUSCH is a PUSCH with a highest modulation and coding scheme (MCS) level among the plurality of PUSCHs.

18. The terminal device according to claim 17, wherein the first PUSCH being related to the transmission parameter of the PUCCH, comprises at least one of:
spatial relation information of the first PUSCH and spatial relation information of the PUCCH indicating a same reference signal;
the spatial relation information of the first PUSCH and the spatial relation information of the PUCCH indicating a quasi-co-located reference signal;
the spatial relation information of the first PUSCH and the spatial relation information of the PUCCH indicating reference signals in a same reference signal resource set;
the first PUSCH and the PUCCH being associated with a same reference signal set;
the first PUSCH and the PUCCH being associated with a same antenna panel identifier; or
the first PUSCH and the PUCCH being associated with a same control resource set (CORESET) pool index.

19. The terminal device according to claim 14, wherein different transport layers of the target PUSCH are transmitted on different antenna panels based on different spatial relation information;
the plurality of PUSCHs comprised in the target PUSCH are transmitted simultaneously on different antenna panels based on different spatial relation information.

20. The terminal device according to claim 14, wherein the time domain resource unit is a slot, a sub-slot, or an orthogonal frequency division multiplexing (OFDM) symbol.
